(19) United States
(12) Patent Application Publication
(10) Pub. No.: US 2019/0092324 A1
(43) Pub. Date: Mar. 28, 2019

(54) SYSTEM AND METHOD FOR DETERMINING COLLISION POINT OF VEHICLE

(71) Applicant: MANDO CORPORATION, Pyeongtaek-si (KR)

(72) Inventor: RakYoung KIM, Yongin-si (KR)

(21) Appl. No.: 16/137,222

(22) Filed: Sep. 20, 2018

(30) Foreign Application Priority Data
Sep. 25, 2017 (KR) 10-2017-0123257

(51) Int. Cl. B60W 30/095; B60Q 9/00; B60W 30/09; G06K 9/00

(52) U.S. Cl. CPC B60W 30/0956; B60Q 9/008; B60W 30/09; B60W 2520/06; B60W 2520/10; B60W 2520/12; G06K 9/00624

(57) ABSTRACT

This disclosure provides a system and a method for determining a collision point of vehicle. According to the system and method, a wheel shape of an object moving in a direction crossing a travel direction of a vehicle is recognized, and a movement angle between the moving object and the vehicle is calculated using the recognized wheel shape. Also, a lateral direction speed and a longitudinal direction speed of the object are accurately calculated using a movement speed of the object and the movement angle of the object, and thus it is possible to accurately determine a time point of collision between the vehicle and the object and prevent collision between the vehicle and the object.

### CROSS REFERENCE TO RELATED APPLICATION

This application claims priority from Korean Patent Application No. 10-2017-0123257, filed on Sep. 25, 2017, which is hereby incorporated by reference for all purposes as if fully set forth herein.

### BACKGROUND OF THE INVENTION

### 1. Field of the invention

The present disclosure relates to a system and method for determining a collision point of vehicle, and more particularly, to a system and method for sensing an object moving near a vehicle and determining a time point of collision between the vehicle and the object.

### 2. Description of the Prior Art

With a recent increase in demand for driver's convenience and safety as well as demand for vehicle performance, vigorous research and development is underway on a driver assist system (DAS) which assists vehicle control on the basis of information acquired through sensors installed in a vehicle.

A system for preventing vehicle collision is one of such DASs.

The system for preventing collision between vehicles senses a position, a speed, etc. of a nearby vehicle using sensors, such as a camera, a radar, etc., installed in a vehicle and warns, when collision between the vehicle and the nearby vehicle is expected, a driver of the vehicle or avoids collision through automatic control of the vehicle.

Here, the system for preventing collision between vehicles estimates a time point of collision by calculating longitudinal direction information and lateral direction information of the nearby vehicle. However, low accuracy is a problem of the longitudinal direction information of the nearby vehicle acquired through a camera and the like installed in the vehicle.

### SUMMARY OF THE INVENTION

In this background, the present disclosure is to provide a system and method for preventing collision between vehicles by sensing a nearby vehicle, which travels near a vehicle, and estimating a time point of collision with the nearby vehicle.

Also, the present disclosure is to provide a system and method for improving accuracy of lateral direction information and longitudinal direction information of a nearby vehicle by recognizing a wheel of the nearby vehicle and calculating a movement angle of the nearby vehicle with a shape of the recognized wheel.

An embodiment provides a system for determining a collision point of vehicle, the system including: a wheel recognizer configured to recognize a wheel shape of an object moving near a vehicle; an angle calculator configured to calculate a movement angle of the object using a first radius and a second radius of the recognized wheel shape; and a collision time point estimator configured to acquire at least one of a longitudinal direction speed and a lateral direction speed of the object on the basis of the movement angle of the object and determine a time point of collision between the vehicle and the object.

The angle calculator of the system for determining a collision point of vehicle may calculate the movement angle of the object using the first radius and the second radius of the wheel shape recognized in a plane perpendicular to a travel direction of the vehicle or may calculate the movement angle of the object using the first radius, which is a vertical radius of the recognized wheel shape, and the second radius, which is a horizontal radius of the recognized wheel shape.

Alternatively, the angle calculator may calculate the movement angle of the object using the first radius, which is the longest radius among radii of the recognized wheel shape, and the second radius, which is the shortest radius among the radii.

Such an angle calculator may calculate the movement angle of the object using a right-angled triangle whose hypotenuse has a length equal to the first radius and of which another side has a length equal to the second radius.

In this case, the collision time point estimator may acquire the longitudinal direction speed and the lateral direction speed of the object using an angle between the first radius and the second radius of the right-angled triangle.

Another embodiment provides a method of determining a collision point of vehicle, the method including: recognizing a wheel shape of an object moving near a vehicle; calculating a movement angle of the object using a first radius and a second radius of the recognized wheel shape; acquiring at least one of a longitudinal direction speed and a lateral direction speed of the object on the basis of the movement angle of the object; and determining a time point of collision between the vehicle and the object.

According to embodiments of the present disclosure, it is possible to recognize a wheel shape of an object (e.g., a nearby vehicle, a bicycle, etc.) moving near a vehicle and calculate a movement angle of the object using the recognized wheel shape.

According to embodiments of the present disclosure, accuracy of lateral direction information and longitudinal direction information of a moving object is improved by recognizing a wheel of the object and calculating a movement angle of the object, and thus it is possible to accurately estimate a time point of collision between a vehicle and the object and prevent collision.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram showing a configuration of a system for determining a collision point of vehicle according to an embodiment of the present disclosure;

FIGS. 2A and 2B are diagrams showing examples of a situation in which a system for determining a collision point of vehicle according to an embodiment of the present disclosure determines a time point of collision with an object having a longitudinal direction speed;

FIGS. 3A and 3B are diagrams showing examples in which a system for determining a collision point of vehicle according to an embodiment of the present disclosure recognizes a wheel of an object;

FIG. 4 is a diagram illustrating a method in which a system for determining a collision point of vehicle according to an embodiment of the present disclosure calculates a movement angle of an object;

FIG. 5 is a diagram illustrating a method in which a system for determining a collision point of vehicle according to an embodiment of the present disclosure acquires a lateral direction speed and a longitudinal direction speed of an object; and

FIG. 6 is a flowchart illustrating a method of determining a collision point of vehicle according to an embodiment of the present disclosure.

### DETAILED DESCRIPTION OF THE EXEMPLARY EMBODIMENTS

Hereinafter, embodiments of the present disclosure will be described in detail with reference to the accompanying drawings. In adding reference numerals to elements in each drawing, the same elements will be designated by the same reference numerals if possible, although they may be shown in different drawings. Further, in the following description of the present disclosure, a detailed description of known functions or configurations incorporated herein will be omitted when it is determined that the description may make the subject matter of the present disclosure rather unclear.

In describing elements of embodiments of the present disclosure, terms such as “first,” “second,” “A,” “B,” “(a),” and “(b)” may be used. Such terms are used only to distinguish an element from another element, but do not limit the substance, sequence, order, number, or the like of elements. It should be noted that when one component is described as being “connected,” “coupled,” or “joined” to another component, still another component may be “connected,” “coupled,” or “joined” between the two components, even though the component may be directly “connected,” “coupled,” or “joined” to the other component.

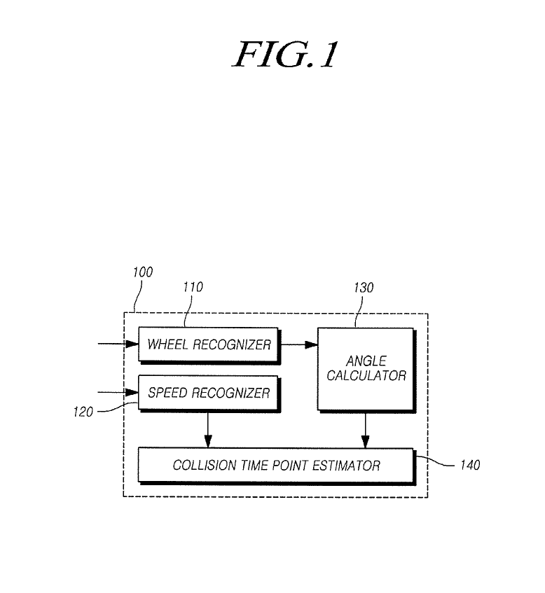

FIG. 1 is a block diagram showing a configuration of a system 100 for determining a collision point of vehicle (referred to as “vehicle collision time point determination system” below) according to an embodiment of the present disclosure.

Referring to FIG. 1, the vehicle collision time point determination system 100 according to an embodiment of the present disclosure includes a wheel recognizer 110 configured to recognize a wheel of an object which moves near a vehicle, a speed recognizer 120 configured to recognize a movement speed of the object, an angle calculator 130 configured to calculate a movement angle of the object using the recognized wheel shape of the object, and a collision time point estimator 140 configured to determine a time point of collision between the vehicle and the object using the movement angle and the movement speed of the object.

The wheel recognizer 110 recognizes the wheel of the object which moves near the vehicle through a camera and the like installed in the vehicle.

The wheel recognizer 110 recognizes a shape of the wheel of the object recognized in a plane which is perpendicular to a travel direction of the vehicle.

For example, when the object moves at right angles to the travel direction of the vehicle, the wheel of the object is positioned in the plane perpendicular to the travel direction of the vehicle. Therefore, the wheel recognizer 110 recognizes the wheel of the object as a circular shape.

When the object moves in a direction diagonal to the travel direction of the vehicle, the wheel of the object is positioned diagonally to the travel direction of the vehicle. Therefore, the wheel recognizer 110 recognizes the wheel of the object as an oval shape shown in the plane perpendicular to the travel direction of the vehicle.

In other words, the wheel shape of the object is recognized differently depending on a movement direction of the object, and thus the recognized wheel shape is used to calculate the movement angle of the object.

The wheel recognizer 110 may recognize the wheel of the object which moves near the vehicle at a certain distance from a position or a travel path of the vehicle. The wheel recognizer 110 may track periodically, or in real time, a position of the object spaced apart by the certain distance from the position or the travel path of the vehicle and recognize the wheel shape. Here, the travel path of the vehicle may be a straight road or a curved road.

The wheel recognizer 110 may recognize a plurality of wheels of the object which moves near the vehicle. When a plurality of wheels are recognized from the object which moves near the vehicle, the wheel recognizer 110 may select one of the plurality of recognized wheels and calculate the movement angle of the object. According to an embodiment of the present disclosure, the wheel recognizer 110 may select a wheel which is close to the travel path of the vehicle. In other words, the wheel recognizer 110 may select a wheel which is positioned in a front part of the object moving near the vehicle.

According to an embodiment of the present disclosure, when the wheel recognizer 110 recognizes a plurality of wheels, the vehicle collision time point determination system 100 may recognize all shapes of the plurality of wheels, calculate respective angles of the wheels, and use an average value of the calculated angles as the movement angle of the object. Alternatively, the vehicle collision time point determination system 100 may give different weights to the respective angles of wheels and calculate the movement angle of the object. For example, a greater weight may be given to a wheel closer to the travel path of the vehicle.

The speed recognizer 120 recognizes a movement speed of the object through the camera, a radar, and the like.

The speed recognizer 120 recognizes the movement speed of the object and transfers the recognized movement speed to the collision time point estimator 140 so that the collision time point estimator 140 may use the movement speed to determine a time point of collision between the vehicle and the object.

The angle calculator 130 calculates a movement angle of the object using the wheel shape of the object recognized by the wheel recognizer 110.

The angle calculator 130 may calculate the movement angle of the object using a first radius, which is a vertical radius, and a second radius, which is a horizontal radius, of the wheel shape of the object recognized by the wheel recognizer 110.

Alternatively, the angle calculator 130 may calculate the movement angle of the object using a first radius, which is the longest radius, and a second radius, which is the shortest radius, of the wheel shape of the object recognized by the wheel recognizer 110.

In other words, when the object moves in a direction diagonal to the vehicle, the wheel shape of the object is recognized as an oval shape. Therefore, the vertical radius is recognized to be the same as an actual radius of the wheel of the object, and the horizontal radius is recognized to be smaller than the actual radius of the wheel of the object.

Thereafter, it is possible to calculate the movement angle of the object using the first radius, which is the vertical radius (or the longest radius) of the wheel shape of the object, and the second radius, which is the horizontal radius (or the shortest radius).

For example, when the wheel of the object positioned diagonally to the travel direction of the vehicle and the recognized wheel shape are looked at from above, an angle between the wheel of the object and the recognized wheel shape is the movement angle of the object.

Here, the actual radius of the wheel of the object and the horizontal radius of the recognized wheel shape form a right-angled triangle.

The actual radius of the wheel of the object corresponds to the first radius of the recognized wheel shape, and the horizontal radius of the recognized wheel shape corresponds to the second radius of the recognized wheel shape.

Therefore, a right-angled triangle is formed to have the first radius of the recognized wheel shape as a hypotenuse and the second radius as one side, and it is possible to calculate an angle between sides corresponding to the first and second radii using the first and second radii.

Since the angle between the sides corresponding to the first and second radii corresponds to the movement angle of the object, the angle calculator 130 transfers the angle between the side corresponding to the first and second radii, that is, the movement angle of the object, to the collision time point estimator 140.

The collision time point estimator 140 calculates a lateral direction speed and a longitudinal direction speed of the object using the movement speed of the object received from the speed recognizer 120 and the movement angle of the object received from the angle calculator 130.

The collision time point estimator 140 determines a time point (referred to as a collision time point below) at which the object is positioned in the travel path of the vehicle on the basis of the lateral direction speed and the longitudinal direction speed of the object.

The vehicle collision time point determination system 100 determines whether a time period from the current time point to the collision time point determined by the collision time point estimator 140 is a preset threshold value or less. The vehicle collision time point determination system 100 may recognize the object moving near the vehicle in real time and modify the collision time point according to movement of the object. When the time period from the current time point to the collision time point is less than the preset threshold value, that is, when it is expected that the object will collide with the vehicle at a time point at which the object is positioned in the travel path of the vehicle, the vehicle collision time point determination system 100 outputs a warning message to the driver or control brakes, steering, or the like of the vehicle so that the vehicle may avoid collision with the object.

According to an embodiment of the present disclosure, a system for preventing collision between a vehicle and an object moving near the vehicle recognizes a wheel shape of the moving object and calculates a movement angle of the object using the recognized wheel shape. Then, the system calculates a lateral direction speed and a longitudinal direction speed of the object using the calculated movement angle of the object so that accuracy of lateral direction information and longitudinal direction information of the object may be improved.

In this way, it is possible to accurately determine a time point of collision between a vehicle and an object and control the vehicle so that collision between the vehicle and the object may be prevented.

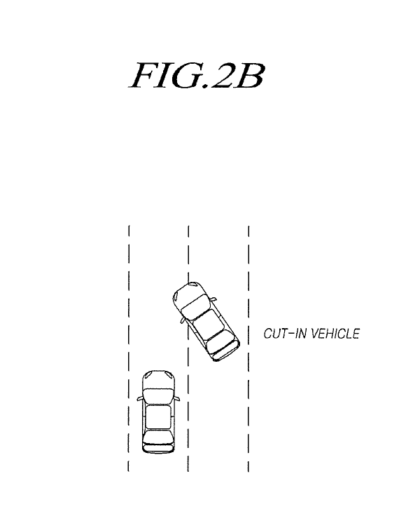

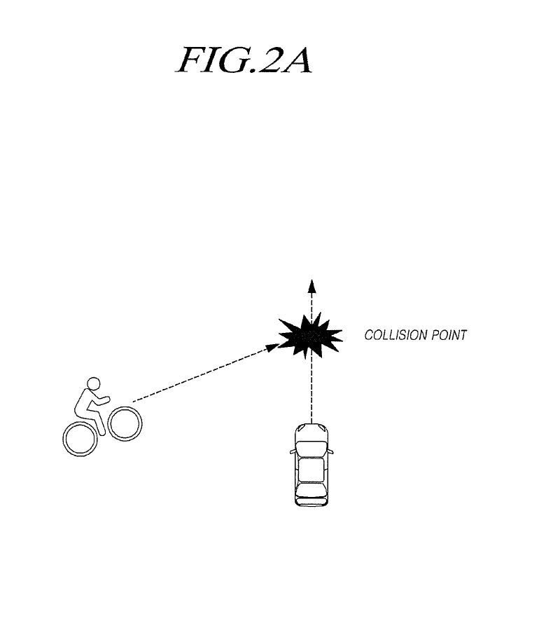

FIGS. 2A and 2B are diagrams showing examples of a situation in which the vehicle collision time point determination system 100 according to an embodiment of the present disclosure determines a time point of collision with an object moving in a direction diagonal to a travel direction of a vehicle.

Referring to FIG. 2A, FIG. 2A shows a situation in which a bicycle on a side of a vehicle moves in a direction diagonal to a travel direction of the vehicle.

When the bicycle moves in a direction perpendicular to the travel direction of the vehicle, it is possible to determine a time point of collision between the vehicle and the bicycle by acquiring only a lateral direction speed of the bicycle. However, when the bicycle moves diagonally, it is necessary to acquire a longitudinal direction speed of the bicycle.

The vehicle collision time point determination system 100 recognizes a wheel shape of the bicycle shown in a plane perpendicular to the travel direction of the vehicle through a camera and the like installed in the vehicle.

Then, the vehicle collision time point determination system 100 may calculate a movement angle of the bicycle using first and second radii of the recognized wheel shape of the bicycle and accurately calculate a lateral direction speed and a longitudinal direction speed of the bicycle using the calculated movement angle.

Consequently, it is possible to accurately calculate a longitudinal direction speed of an object moving near a vehicle and accurately determine a time point of collision between the vehicle and the object so that collision between the vehicle and the object may be prevented.

The method of preventing collision by recognizing a wheel shape of an object may also be applied to a case in which a vehicle travels near another vehicle.

Referring to FIG. 2B, FIG. 2B shows a situation in which another vehicle traveling in a lane to a side of a traveling vehicle cuts in front of the other vehicle.

When another vehicle cuts in front of a vehicle traveling in a lane to a side of the other vehicle, a wheel of the other vehicle is recognized as an oval shape.

The vehicle collision time point determination system 100 calculates first and second radii from the wheel shape of the other vehicle recognized as an oval shape and calculates a movement angle of the other vehicle using the first and second radii.

Then, the vehicle collision time point determination system 100 calculates a lateral direction speed and a longitudinal direction speed of the other vehicle using the calculated movement angle and a movement speed of the other vehicle.

The vehicle collision time point determination system 100 determines a time point of collision between the vehicle and the other vehicle on the basis of the lateral direction speed and the longitudinal direction speed of the other vehicle and controls the vehicle so that the vehicle may avoid collision when collision is expected between the vehicle and the other vehicle.

Therefore, accurate calculation of a lateral direction speed and a longitudinal direction speed of another vehicle cutting in front of a vehicle makes it possible to accurately determine a time point of collision between the vehicle and the other vehicle and prevent collision.

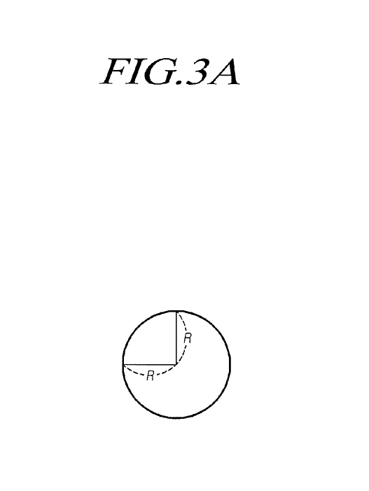

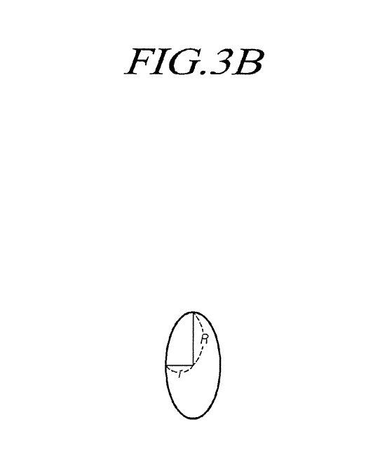

FIGS. 3A and 3B show examples of a wheel shape of an object recognized according to a movement angle of the object by the vehicle collision time point determination system 100 according to an embodiment of the present disclosure.

Referring to FIG. 3A, FIG. 3A shows a wheel shape of an object recognized when the object moves near a vehicle in a direction perpendicular to a travel direction of the vehicle.

Since the object moves in a direction perpendicular to the travel direction of the vehicle, the wheel of the object is recognized as a circular shape.

Therefore, as shown in FIG. 3A, a first radius, which is a vertical radius (or the longest radius), and a second radius, which is a horizontal radius (or the shortest radius), are recognized as identical lengths R in the recognized wheel shape.

When the first radius and the second radius are recognized to be identical to each other in the recognized wheel shape of the object, the vehicle collision time point determination system 100 may determine that the object moves in a direction perpendicular to the travel direction of the vehicle.

Therefore, the vehicle collision time point determination system 100 calculates only a lateral direction speed of the object, determines a time point of collision between the vehicle and the object, and controls the vehicle so that the vehicle may avoid collision.

On the other hand, when an object moves in a direction diagonal to a travel direction of a vehicle, a wheel of the object is recognized as an oval shape.

FIG. 3B shows a wheel shape of an object recognized when the object moves near a vehicle in a direction diagonal to a travel direction of the vehicle.

As shown in FIG. 3B, since the object moves in a direction diagonal to the travel direction of the vehicle, a wheel of the object is recognized as an oval shape, and first and second radii are recognized as R and r, respectively.

Since the first and second radii are different in the recognized wheel shape of the object, the vehicle collision time point determination system 100 may determine that the object moves in a direction diagonal to the travel direction of the vehicle and has a longitudinal direction speed.

The vehicle collision time point determination system 100 may calculate a movement angle of the object using the first and second radii of the recognized wheel shape of the object.

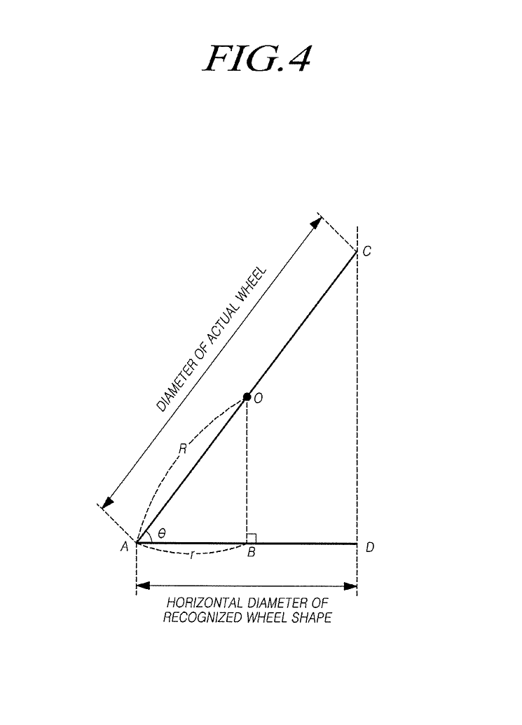

FIG. 4 shows an example of a method in which the vehicle collision time point determination system 100 according to an embodiment of the present disclosure calculates a movement angle of an object using first and second radii of a recognized wheel shape of an object.

Referring to FIG. 4, when an object moves in a direction diagonal to a travel direction of a vehicle, an actual position of a wheel of the object and the recognized wheel shape may be looked at from above. In this case, an actual radius of the wheel of the object and a horizontal radius of the recognized wheel shape form a right-angled triangle.

Here, the actual radius of the wheel of the object is the same as a vertical radius of the recognize wheel shape.

Also, an angle between the actual position of the wheel of the object and a position of the recognized wheel of the object is a movement angle of the object.

Therefore, it is possible to see that a right-angled triangle (ΔOAB) is formed to have the first radius of the recognized wheel of the object as a hypertenuse and the second radius as another side (segment AB), and an angle between the sides corresponding to the first and second radii is a movement angle (∠θ) of the object.

In other words, a top-down view of an actual position of a wheel of an object and a position of a recognized wheel may be derived from first and second radii of the wheel of the object recognized in a plane perpendicular to a travel direction of a vehicle.

Then, a movement angle of the object may be calculated through the top-down view, and thus it is possible to calculate a lateral direction speed and a longitudinal direction speed of the object moving in a direction diagonal to the travel direction of the vehicle.

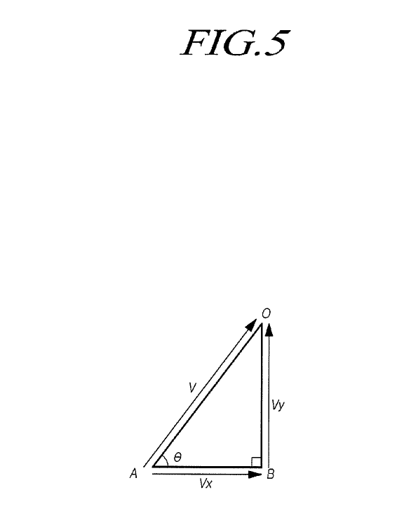

FIG. 5 shows an example of a method in which the vehicle collision time point determination system 100 according to an embodiment of the present disclosure calculates a lateral direction speed and a longitudinal direction speed of an object.

Referring to FIG. 5, the vehicle collision time point determination system 100 recognizes a movement speed V of an object through the speed recognizer 120.

Also, from a wheel shape of the object recognized in a plane perpendicular to a travel direction of a vehicle, the vehicle collision time point determination system 100 derives a right-angled triangle (ΔOAB) which has segment OA (a first radius of the recognized wheel shape) and segment AB (a second radius of the recognized wheel shape) as two sides.

Since the vehicle collision time point determination system 100 may determine a movement angle (∠θ) of the object from the right-angled triangle, it is possible to calculate a lateral direction speed Vx of the object using the movement speed V of the object and the cosine function value of the movement angle (∠θ). Also, the vehicle collision time point determination system 100 may calculate a longitudinal direction speed Vy using the movement speed V of the object and the sine function value of the movement angle (φθ).

The vehicle collision time point determination system 100 may calculate the lateral direction speed Vx and the longitudinal direction speed Vy of the object and determine a time point of collision between the vehicle and the object using the calculated lateral direction information and longitudinal direction information of the object.

When collision is expected between the vehicle and the object, the vehicle collision time point determination system 100 may output a warning message to a driver of the vehicle, or control brakes, steering, or the like of the vehicle so that the vehicle may avoid collision with the object.

In other words, according to an embodiment of the present disclosure, a lateral direction speed and a longitudinal direction speed of an object which moves in a direction diagonal to a travel direction of a vehicle may be accurately calculated by recognizing a wheel shape of the object. Therefore, it is possible to accurately determine a time point of collision between the vehicle and the object and control the vehicle so that the vehicle may avoid collision with the object.

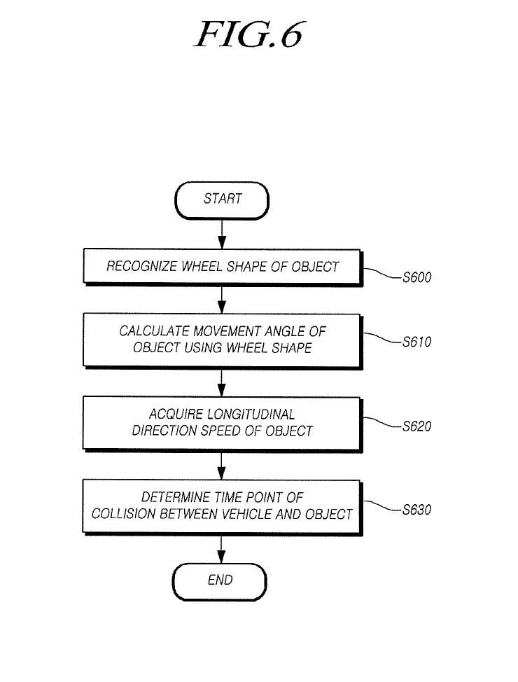

FIG. 6 shows a process in which the vehicle collision time point determination system 100 according to an embodiment of the present disclosure determines a time point of collision with a moving object by recognizing a wheel of the object.

Referring to FIG. 6, the vehicle collision time point determination system 100 recognizes a wheel shape of an object which moves in a direction crossing a travel direction of a vehicle (S600).

The vehicle collision time point determination system 100 determines a first radius, which is a vertical radius (or the longest radius) of the recognized wheel shape, and a second radius, which is a horizontal radius (or the shortest radius).

When the first and second radii are identical, it is determined that the object moves in a direction perpendicular to the travel direction of the vehicle.

When the first radius is shorter than the second radius, it is determined that the object moves in a direction diagonal to the travel direction of the vehicle.

The vehicle collision time point determination system 100 may track periodically, or in real time, the wheel of the object which is spaced apart by a certain distance from the position or a travel path of the vehicle and moves near the vehicle.

The vehicle collision time point determination system 100 may recognize a plurality of wheels of the object which moves near the vehicle. When a plurality of wheels are recognized from the object which moves near the vehicle, the vehicle collision time point determination system 100 may select one of the plurality of recognized wheels and calculate a movement angle of the object. According to an embodiment of the present disclosure, the vehicle collision time point determination system 100 may select a wheel which is close to the travel path of the vehicle. In other words, the vehicle collision time point determination system 100 may select a wheel which is positioned in a front part of the object moving near the vehicle.

The vehicle collision time point determination system 100 calculates a movement angle of the object using the first and second radii of the recognized wheel shape of the object (S610).

A top-down view of an actual position of the wheel of the object and a position of the recognized wheel may be derived from the first and second radii of the recognized wheel shape.

For example, it is possible to derive a right-angled triangle having the first radius as a hypotenuse and the second radus as another side. Then, a movement angle of the object may be calculated from an angle between sides of the right-angled triangle corresponding to the first and second radii.

According to an embodiment of the present disclosure, when a plurality of wheels are recognized, the vehicle collision time point determination system 100 may recognize all shapes of the plurality of wheels, calculate respective angles of the wheels, and use an average value of the calculated angles as the movement angle of the object. Alternatively, the vehicle collision time point determination system 100 may give different weights to the respective angles of wheels and calculate the movement angle of the object. For example, a greater weight may be given to a wheel closer to the travel path of the vehicle.

The vehicle collision time point determination system 100 acquires a lateral direction speed and a longitudinal direction speed of the object using a movement speed and the movement angle of the vehicle (S620).

The vehicle collision time point determination system 100 determines a time point of collision between the vehicle and the object using the lateral direction speed and the longitudinal direction speed of the object (S630). The vehicle collision time point determination system 100 determines whether a time period from the current time point to the collision time point determined is a preset threshold value or less. When the time period from the current time point to the collision time point is less than the preset threshold value, that is, when collision is expected between the vehicle and the object, the vehicle collision time point determination system 100 controls the vehicle so that the vehicle may avoid collision with the object.

According to embodiments of the present disclosure, it is possible to recognize a wheel shape of an object (e.g., a nearby vehicle, a bicycle, etc.) moving near a vehicle and calculate a movement angle of the object using the recognized wheel shape.

According to embodiments of the present disclosure, accuracy of lateral direction information and longitudinal direction information of a moving object is improved by recognizing a wheel of the object and calculating a movement angle of the object, and thus it is possible to accurately estimate a time point of collision between a vehicle and the object and prevent collision.

The above embodiments of the present disclosure have been described only for illustrative purposes, and those skilled in the art will appreciate that various modifications and changes may be made thereto without departing from the essential features of the disclosure. Therefore, the embodiments of the present disclosure are not intended to limit, but are intended to illustrate the technical idea of the present disclosure, and the scope of the technical idea of the present disclosure is not limited by the embodiments. The scope of the present disclosure shall be construed on the basis of the accompanying claims in such a manner that all of the technical ideas included within the scope equivalent to the claims belong to the present disclosure.

What is claimed is:

1. A system for determining a collision point of vehicle, the system comprising:
a wheel recognizer configured to recognize a wheel shape of an object moving near a vehicle;
an angle calculator configured to calculate a movement angle of the object using a first radius and a second radius of the recognized wheel shape; and
a collision time point estimator configured to acquire at least one of a longitudinal direction speed and a lateral direction speed of the object based on the movement angle of the object and determine a time point of collision between the vehicle and the object.

2. The system of claim 1, wherein when a plurality of wheel shapes are recognized by the wheel recognizer, the wheel recognizer selects a wheel shape closest to a travel path of the vehicle.

3. The system of claim 1, wherein the angle calculator calculates the movement angle of the object using a right-angled triangle having the first radius as a hypotenuse and the second radius as another side.

4. The system of claim 1, wherein the angle calculator calculates the movement angle of the object using the first radius, which is a vertical radius of the recognized wheel shape, and the second radius, which is a horizontal radius of the recognized wheel shape.

5. The system of claim 1, wherein the angle calculator calculates the movement angle of the object using the first radius, which is a longest one of radii of the recognized wheel shape, and the second radius, which is a shortest one of radii of the recognized wheel shape.

6. The system of claim 1, wherein the angle calculator calculates the movement angle of the object using the first radius and the second radius of the wheel shape recognized in a plane perpendicular to a travel direction of the vehicle.

7. The system of claim 1, wherein when a time period from a current time point to the time point of collision is a preset threshold value or less, the collision time point estimator outputs a warning message or controls a velocity of the vehicle.

8. A method of determining a collision point of vehicle, the method comprising:
recognizing a wheel shape of an object moving near a vehicle;
calculating a movement angle of the object using a first radius and a second radius of the recognized wheel shape;
acquiring at least one of a longitudinal direction speed and a lateral direction speed of the object based on the movement angle of the object; and
determining a time point of collision between the vehicle and the object.

9. The method of claim 8, wherein when a plurality of wheel shapes are recognized, the recognizing of the wheel shape of the object comprises selecting a wheel shape closest to a travel path of the vehicle.

10. The method of claim 8, wherein the calculating of the movement angle of the object comprises calculating the movement angle of the object using a right-angled triangle having the first radius as a hypotenuse and the second radius as another side.

11. The method of claim 8, wherein the calculating of the movement angle of the object comprises calculating the movement angle of the object using the first radius, which is a vertical radius of the recognized wheel shape, and the second radius, which is a horizontal radius of the recognized wheel shape.

12. The method of claim 8, wherein the calculating of the movement angle of the object comprises calculating the movement angle of the object using the first radius, which is a longest one of radii of the recognized wheel shape, and the second radius, which is a shortest one of radii of the recognized wheel shape.

13. The method of claim 8, wherein the calculating of the movement angle of the object comprises calculating the movement angle of the object using the first radius and the second radius of the wheel shape recognized in a plane perpendicular to a travel direction of the vehicle.

14. The method of claim 8, wherein the determining of the time point of collision between the vehicle and the object comprises, when a time period from a current time point to the time point of collision is a preset threshold value or less, outputting a warning message or controlling a velocity of the vehicle.
